(19) United States
(12) Patent Application Publication
(10) Pub. No.: US 2019/0230480 A1
(43) Pub. Date: Jul. 25, 2019

(54) APPARATUS AND METHODS FOR TRANSFERRING MESSAGES BETWEEN NETWORKS

(71) Applicant: Huawei Technologies Co., Ltd., Shenzhen (CN)

(72) Inventors: Alexandros KALOXYLOS, Munich (DE); Panagiotis SPAPIS, Munich (DE); Chan ZHOU, Munich (DE); Chenghui PENG, Munich (DE)

(21) Appl. No.: 16/376,761

(22) Filed: Apr. 5, 2019

Related U.S. Application Data
(63) Continuation of application No. PCT/EP2016/073780, filed on Oct. 5, 2016.

(51) Int. Cl. H04W 4/06; H04W 60/00; H04W 88/18; H04W 88/08; H04W 76/11; H04W 4/70

(52) U.S. Cl. CPC H04W 4/06; H04W 60/00; H04W 4/70; H04W 88/085; H04W 76/11; H04W 88/184

(57) ABSTRACT

A relay device for operating in a communication system that comprises at least two individual networks. The networks may be “individual” in the sense that they are different from each other. Different networks comprise different functionalities. In particular, different networks will tend to operate in different spectrum, have separate authorization and/or authentication procedures and/or apply different transmission technologies. Each network comprises a network device and a remote device that are configured to wirelessly transfer data between them. The relay device is configured to receive data transmitted by a device in a first one of the networks over a first section of radio spectrum. It is also configured to transmit that data to a device in a second one of the networks over a second section of radio spectrum that is different from the first section of radio spectrum.

### CROSS REFERENCE TO RELATED APPLICATIONS

This application is a continuation of International Application No. PCT/EP2016/073780, filed on Oct. 5, 2016, the disclosure of which is hereby incorporated by reference in its entirety.

### TECHNICAL FIELD

The embodiments of the invention relates to apparatus and methods for relaying messages between different networks.

### BACKGROUND

Wireless networks operators are currently working towards providing services with extremely low latency and high reliability in order to meet the stringent requirements for new use cases that will have to be supported with the arrival of 5G cellular networks. One particular use case relates to vehicle-related communication (referred to as “V2X”). V2X communication will enable a number of traffic safety applications (see 3GPP: “TR 22.885, Study on LTE support for Vehicle to Everything (V2X) services,” v14.0.0, December 2015). It will also play an important role in future automated driving systems (see NGMN, “5G White Paper,” v1.0, February 2015). The white paper defines that use cases such as short-distance platooning and automated cooperative manoeuvre will have a maximum tolerated end-to-end latency of 1 ms.

One option for reducing delays in a communication network is to move the network functions and the application server for ITS (Intelligent Transport Systems) services close to the mobile devices. For example, these functions could be directly embedded in the base station. This concept is generally denoted as Mobile Edge Computing (MEC) (see ETSI, “Mobile-Edge Computing—Introductory Technical White Paper,” September 2014). These concepts aim to perform any data exchange among remote devices locally, supported by a subset of network components so that the communication delay is minimized.

Most of the MEC solutions are based on an assumption that all mobile devices are operated by the same network. A V2X environment could encompass mobile devices that are user equipment (UEs) on-board vehicles, personal UE/smart phones used by pedestrians and Road Side Units (RSUs). In real life situations, it is likely that vehicles and pedestrians located in the same area will be serviced by different operators. Therefore, they will connect to different networks and different base stations. Different networks comprise different functionalities in at least one of the following: the networks operate in different spectrum; have separate authorization and/or authentication procedures; apply different transmission technologies, e.g. CDMA, OFDM. In addition, future cellular networks will be designed to support multiple “network slices”. A “network slice” will be a fully operational logical network containing all required protocols and network resources. However, if two network slices are configured to use different spectrum from each other, even mobile devices that are served by the same operator could present the same challenges if they are connected to different network slices deployed by that operator.

To illustrate why having mobile devices connected to different networks is problematic for the stringent requirements of the new use cases, FIG. 1 shows an example of two networks 101, 102 that are each configured according to a current 3GPP LTE communication standard. A data package sent by a user equipment UE1 (103) in one network will be transmitted firstly to its home base station (Home eNodeB) 104 via the uplink. Then it will pass through the Serving Gateway (S-GW) 105 and the Packet Gateway (P-GW) 106 of the home network before being forwarded to the registered network of the targeted user equipment UE2 (107). The data package passes through the P-GW (108), S-GW (109) and eNodeB (110) of the targeted network. Finally, the targeted UE2 receives the data packet from its home eNodeB in the downlink. This chain of transfers introduces a delay that is not acceptable for delay critical communications such as the use cases encompassed by V2X communication.

### SUMMARY

It is an object of the embodiments of the invention to provide concepts for improving the transfer of data from one network to another.

The foregoing and other objects are achieved by the features of the independent claims. Further implementation forms are apparent from the dependent claims, the description and the figures.

According a first aspect, a relay device is provided for operating in a communication system that comprises at least two individual networks, wherein each network comprises a network device and a remote device that are configured to wirelessly transfer data between them. The relay device is configured to receive data transmitted by a device in a first one of the networks over a first section of radio spectrum. It is also configured to transmit that data to a device in a second one of the networks over a second section of radio spectrum that is different from the first section of radio spectrum. The relay device is able to relay messages from one network to another and thus provide a shortcut compared with conventional data exchange between networks that involves crossing all domains of multiple networks. The relay device significantly reduces the delay associated with transferring data from one network to another, enabling the networks to fulfill strict delay requirements.

The relay device may be configured to receive the data from a network device or from a remote device in the first network. The relay device may be configured to transmit the data to a network device or to a remote device in the second network. The relay device is thus capable of handling a wide variety of data exchanges between devices in the two networks. The device is also capable of transmitting data via an uplink, a downlink or a direct link, depending what it appropriate to the situation.

The relay device may be configured to be able to decode the data transmitted by the device in the first network. The relay device is thus capable of successfully receiving data that has been transmitted in the first network, which in turn enables it to successfully transmit that data in the second network.

The relay device may be configured to receive information from a network device about a transmission, in the first network, of data that the relay device should relay to the second network and listen for that data transmission in dependence on that information. The relay device is thus capable of efficiently receiving data in the first network by listening to appropriate time and/or frequency slots.

The relay device may be configured to listen to a radio resource that is pre-allocated by the first network for data that should be relayed to the second network. The relay device is thereby capable of receiving the data transmitted by the device in the first network without having to receive information about that transmission from the first network beforehand. This saves time and signalling load since the relay device is able to listen for messages without needing specific information from the network first.

The relay device may be configured to listen to a broadcast channel of the first network for data that it should relay to the second network. The relay device may be configured to relay any such data to the second network by transmitting it on a broadcast channel of the second network. The relay device is thus able to retain the original broadcast quality of the data, even when not all of the remote devices that the data was broadcast to are in the network where the data was originally broadcast.

The relay device may be registered in the first or second network as being part of one or more multicast groups of remote devices that are registered in that respective network. In this way the relay device is automatically forwarded multicast messages that need to be relayed to a different network.

The relay device may be configured to request radio resources from a network device in the second network for transmitting the data that it received from a device in the first network to a device in the second network. The relay device may be configured to transmit that data to the device in the second network using the requested radio resources. The relay device is thus able to access the spectrum that it needs in the second network for relaying data to one or more devices in that network.

The relay device may be configured to transmit the data that it received from the device in the first network to the device in the second network over a radio resource that is pre-allocated to relaying data to the second network. The relay device may thereby be capable of transmitting the data to the device in the second network without having to request radio resources from the second network beforehand. This saves time and signalling load since the relay device is able to transmit for messages without needing to request a specific allocation of resources first.

The relay device may be registered in the first network and/or in the second network as a device that has permission to perform one or more of: receiving data; transmitting data and decoding data transmitted by a remote device and/or a network device in the first network. In one preferred embodiment the relay device is registered in both the first network and the second network, so it is registered in two different networks simultaneously. For example, the relay device may be registered in the first network and/or the second network as one or more of: a remote device; a common remote device; a relay device; and a special relay device. In this way the relay device is recognised by the network as being a type of device which is inherently authorised to receive and decode the data that it needs to perform its relaying function.

According to a second aspect, a method is provided for relaying data in a communication system that comprises at least two individual networks, wherein each network comprises a network device and a remote device that are configured to wirelessly transfer data between them. The method comprises receiving data transmitted by a device in a first one of the networks over a first section of radio spectrum at a relay device. The method also comprises transmitting that data from the relay device to a device in a second one of the networks over a second section of radio spectrum, which is different from the first section of radio spectrum.

According to a third aspect, a non-transitory machine readable storage medium is provided that has stored thereon processor executable instructions implementing a method for relaying data in a communication system that comprises at least two individual networks, wherein each network comprises a network device and a remote device that are configured to wirelessly transfer data between them. The instructions implement a method comprising receiving data transmitted by a device in a first one of the networks over a first section of radio spectrum at a relay device. The instructions also implement a method comprising transmitting that data from the relay device to a device in a second one of the networks over a second section of radio spectrum, which is different from the first section of radio spectrum.

According to a fourth aspect, a network device is provided that is configured to allocate radio resources to a transmission of data, wherein said data is to be relayed from a first network, which is configured to communicate its data using a first section of radio spectrum, to a second network, which is configured to communicate its data using a second section of radio spectrum that is different from the first section of radio spectrum. The network device is configured to facilitate the relaying of that data from the first network to the second network by configuring a device that is intended to receive the data transmission to receive that transmission via the allocated radio resources. The network device is thus capable of configuring a device—which in some embodiments may be a relay device—so that the device is capable of relaying data between two different networks. This may significantly reduce the delay associated with transferring data between the two networks.

### BRIEF DESCRIPTION OF DRAWINGS

The present embodiments of the invention will now be described by way of example with reference to the accompanying drawings. In the drawings:

FIG. 1 shows an example of packet transmission through two networks, that belong to different operators;

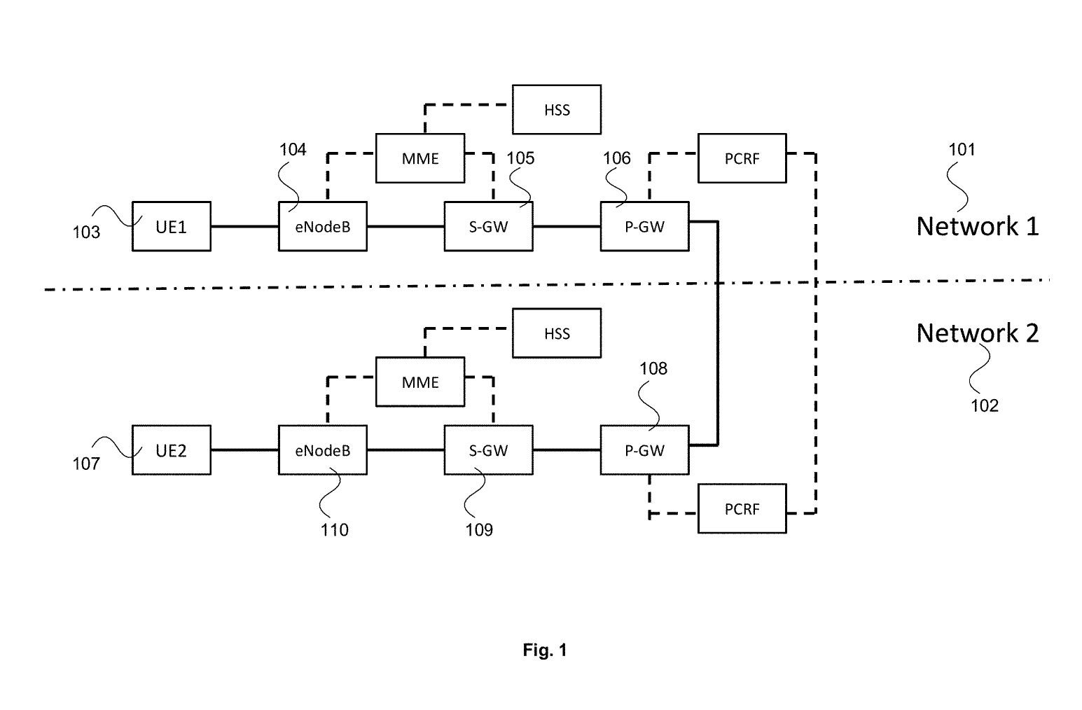

FIG. 2 shows an example of two user equipment that are communicating with different networks;

FIG. 3 shows an example of a relay device according to one embodiment of the invention;

FIG. 4 shows an example of a network device according to one embodiment of the invention;

FIG. 5 shows an example of a possible processes for relaying data from one network to another;

FIG. 6 shows a relay device relaying a message from one remote device to a base station, which transmits it to another remote device;

FIG. 7 shows a signalling exchange for relaying a message from one remote device to a base station, which transmits it to another remote device;

FIG. 8 shows a relay device relaying a message from a base station to a remote device;

FIG. 9 shows a signalling exchange for relaying a message from a base station to a remote device;

FIG. 10 shows a relay device relaying a message from a base station to another base station;

FIG. 11 shows a signalling exchange for relaying a message from a base station to another base station;

FIG. 12 a relay device relaying a message from one remote device to another using direct links; and

FIG. 13 shows a signalling exchange for establishing direct links.

### DESCRIPTION OF EMBODIMENTS

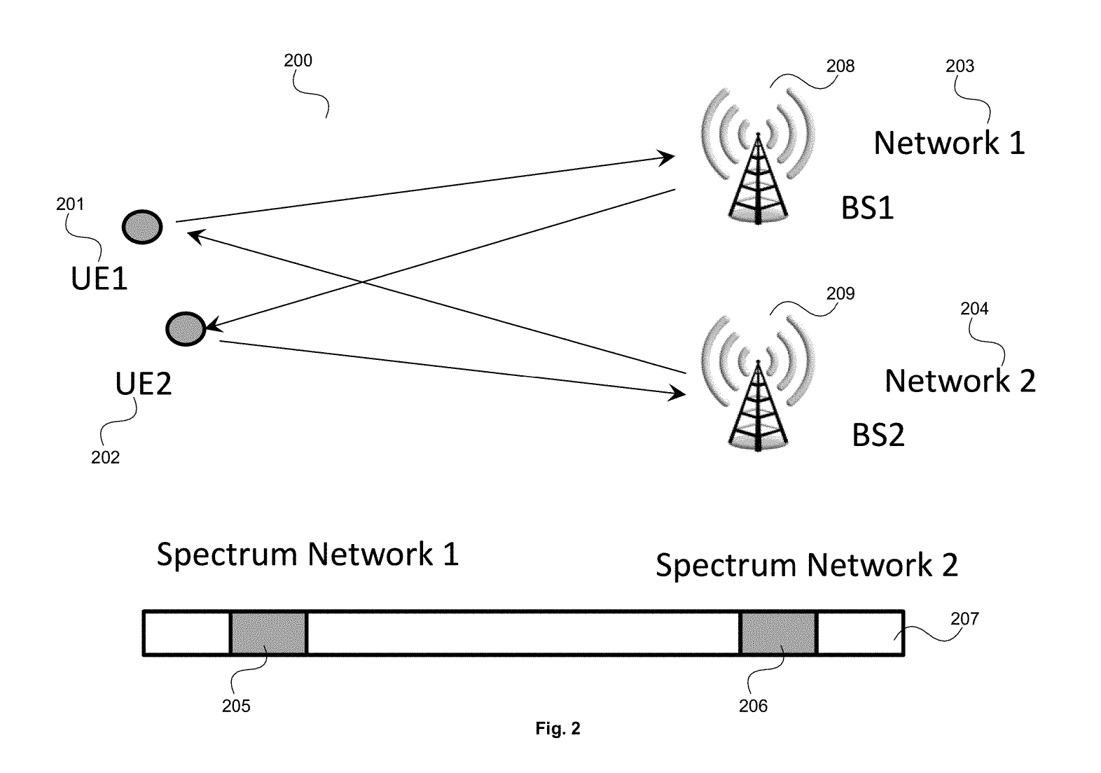

FIG. 2 illustrates an example of a communication system 200 that comprises two remote devices 201, 202, each of which are configured to communicate with a respective network 203, 204. For example, each remote device may be connected to its respective network. The two networks are physically separate, and each remote device is configured to wirelessly transfer data with a network device (208, 209) belonging to its respective network. The remote devices are generally denoted as user equipment or “UE” herein and they could be any device with a wireless communication capability, including e.g. autonomous vehicle control systems, GPS navigation systems, mobile phones, smart phones, laptops, tablets etc.

Each network device is represented illustratively in FIG. 2 by a base station. It should be understood that the term “network device” is intended to cover any apparatus that is capable of direct wireless communication with remote devices 201, 202. This apparatus forms part of the radio access domain of network 104. Each network suitably includes backhaul and core domains in addition to the radio access domain.

The networks are individual in the sense that they are different from each other. Different networks comprise different functionalities. In particular, different networks will tend to have different functionality in at least one of the following: the networks operate in different spectrum; the networks have separate authorization and/or authentication procedures; the networks apply different transmission technologies, e.g. CDMA, OFDM.

In some scenarios the networks (203, 204) may be deployed by different operators. In other scenarios the networks may be deployed by the same operator but represent different network “slices”. Each “slice” is a logical network that is operationally independent of its fellow network slices. Each network slice may distinguish itself from the other network slices deployed by having a different configuration and parameterization. In the example of FIG. 2, the first network 203 is configured to use a first section (205) of radio spectrum 207. The second network 206 is configured to use a second section (205) of radio spectrum 207. The two sections of radio spectrum are different from each other, as shown in the figure.

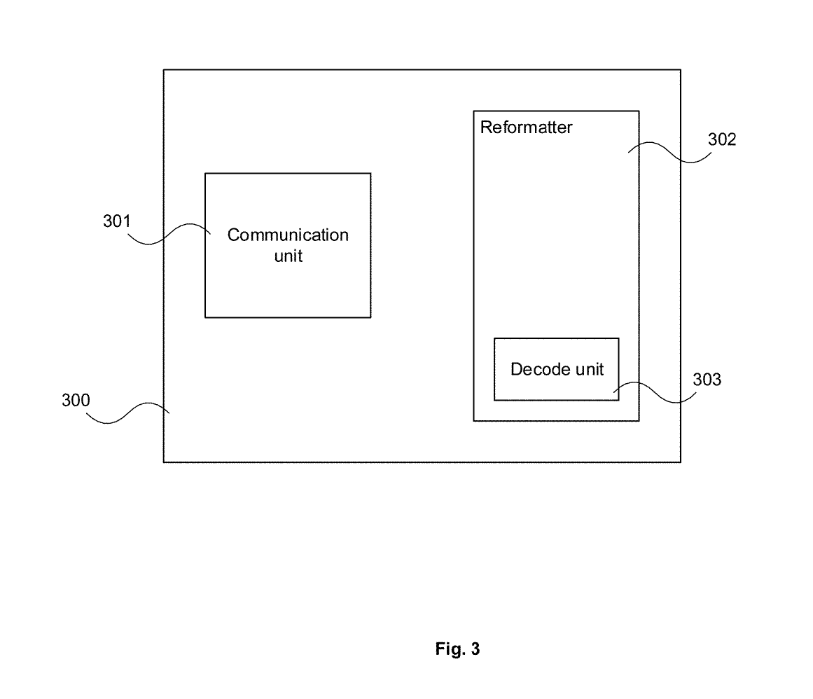

FIG. 3 illustrates an example of a relay device 300. The relay device is suitably configured to operate in a communication system such as that shown in FIG. 2. The relay device comprises a communication unit 301 that is configured to receive data transmitted by a device in a first network over a first section of radio spectrum. It is also configured to transmit that data to a device in a second network over a second section of radio spectrum. The first and second sections of radio spectrum are different from each other, as shown in FIG. 2. In most implementations, the communication unit is likely to incorporate a transceiver unit that is capable of both transmitting and receiving wireless data.

The relay device (300) is likely to receive the data in the format of a message, so may also optionally comprise a reformatter (302) that is configured to perform any reformatting that might need to occur before the relay device can transmit a message that it has received from the first network over the second network. For example, the reformatter suitably includes a decode unit (303) for decoding or unscrambling messages that it receives from the first network. The reformatter is suitably configured to apply any coding or scrambling that might be required in the second network before transmitting any messages in that network.

The relay device may be implemented as a standalone relay device that is deployed in targeted areas. It can also be implemented as part of an existing network entity, such as a Road Side Unit (RSU) or base station (e.g. an eNodeB).

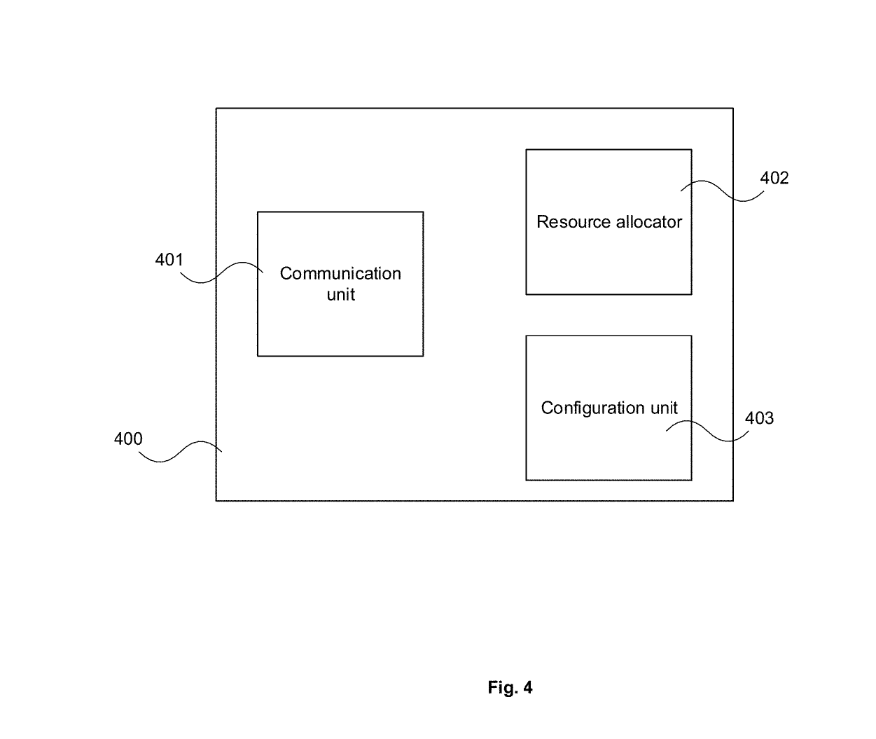

FIG. 4 illustrates an example of a network device 400. The network device comprises a communication unit 401, a resource allocator 402 and a configuration unit 403. The resource allocator is configured to allocate radio resources for the transmission of data. In one scenario this data is to be relayed from a first network to a second network.

The first network is configured to communicate its data using a first section of radio spectrum. The second network is configured to communicate its data using a second section of radio spectrum.

As before, the first and second sections of radio spectrum are different from each other. The configuration unit and the communication unit are together configured to facilitate the relaying of that data from the first network to the second network. In practice they are likely to achieve this by the configuration unit generating information that the communication unit then sends as one or messages for configuring a device that is intended to receive the data transmission via the allocated radio resources.

The structures shown in FIGS. 3 and 4 (and all the block apparatus diagrams included herein) are intended to correspond to a number of functional blocks. This is for illustrative purposes only. FIGS. 3 and 4 are not intended to define a strict division between different parts of hardware on a chip or between different programs, procedures or functions in software.

In some embodiments, some or all of the signalling techniques described herein will be coordinated wholly or partly by a processor acting under software control. That software can be embodied in a non-transitory machine readable storage medium having stored thereon processor executable instructions for implementing some or all of the signalling procedures described herein.

For the relay node the processor could, for example, be a central processor of a standalone apparatus implementing the relay device. It could also be implemented by a processor of an existing network entity, such as a Road Side Unit (RSU) or base station (e.g. an eNodeB). For the network device, the processor could be a central processor of a base station or other device forming part of the radio access network, or it could be part of the processing capability of a server in the core network.

Some or all of the signal processing operations described herein might also be performed wholly or partly in hardware. This particularly applies to techniques incorporating repetitive operations, such as the formation of standard messages. It also applies to transmit and receive techniques; any transmitters and receivers described herein are likely to include dedicated hardware to perform functions such as frequency mixing, code cover mixing, symbol demapping, frequency transforms, subcarrier demapping etc.

The specific components found in any transmitters and receivers will be dependent on the exact waveform and telecommunications protocol that the receiver is configured to implement. One or more implementations of the embodiments of the invention are described below with reference to an application in which the receiver is configured to operate in accordance with a 3GPP LTE standard. This is for the purposes of example only; it should be understood that the scope of the embodiments of the invention is not limited to any particular waveform or telecommunications protocol and any suitable waveform or telecommunications protocol could be used.

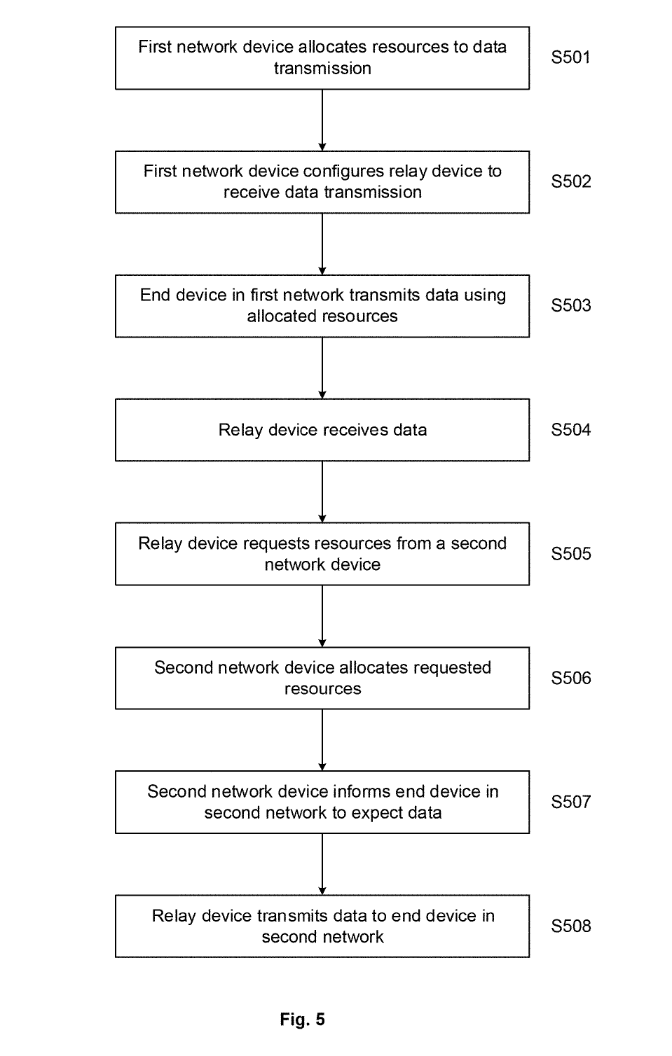

The relay device and the network device may work together to implement a process for forwarding messages from one network to another. An overview of one possible processes is shown in FIG. 5. In FIG. 5, the process starts with a first network device allocating resources to a data transmission (step S501). The first network device also configures the relay device to receive the transmitted data (step S502).

In step S503, a device in the same network as the first network device transmits the data using the allocated resources. This data is received by the relay device in step S504.

In step S505, the relay device requests resources from a second network device so that it can transmit the data to a remote device in the second network. The second network device allocates the requested resources to the relay device (step S506). It may also inform the remote device to expect the data transmission (step S507). Finally, the relay device transmits the data to the remote device using the allocated resources of the second network (step S508).

The process shown in FIG. 5 is an example that gives an overview of the steps that may be involved in relaying data from one network to another according to one or more embodiments of the invention. In a practical implementation that is tailored to a specific scenario, one or more steps shown in FIG. 5 may be omitted and/or other steps might be added, as will be apparent from the following specific examples.

Relay Messages from a Transmitting Remote Device

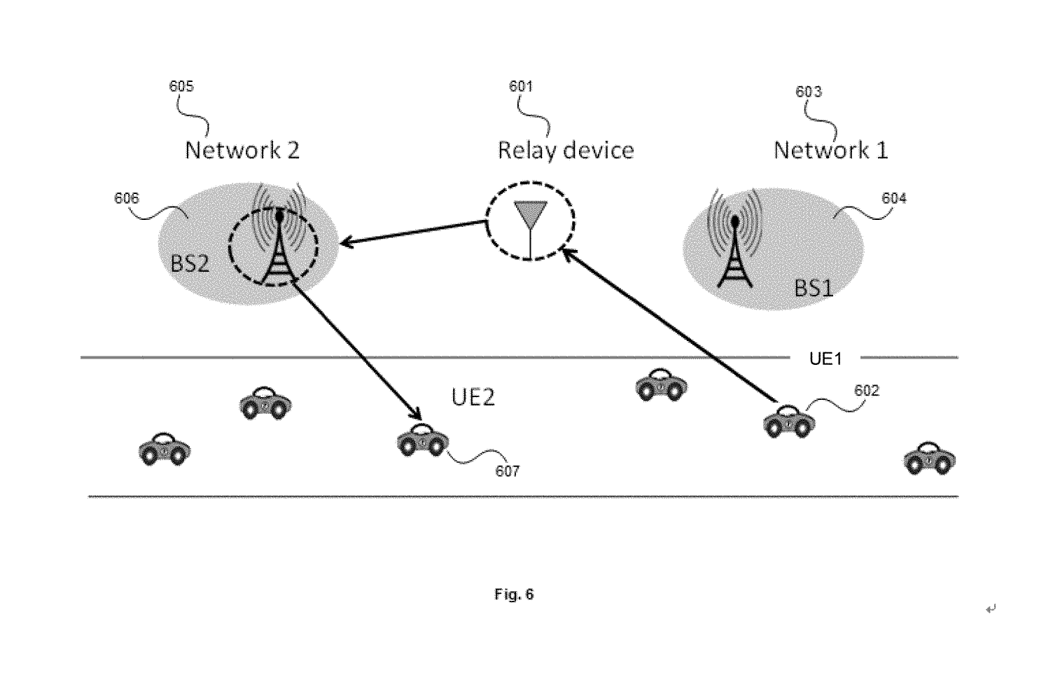

An example of this scenario is shown in FIG. 6. The relay device 601 is configured to receive data from a remote device 602 in the first network 603. The relay device receives this data as a message from UE1 (602) that is transmitted in the spectrum of Network 1. UE1 is connected to a network device BS1 (604) in Network 1 and hence transmits its message using the spectrum of BS1. The relay device listens to the message sent using this first section of spectrum.

In this example the relay device is configured to transmit the data to a network device (606) in the second network (605). The relay device forwards the message to a base station BS2 (606) of Network 2 (605) using the spectrum of BS2. BS2 receives the message in its spectrum, and finally forwards it to the second remote device UE2 (607), which is connected to BS2, via the downlink.

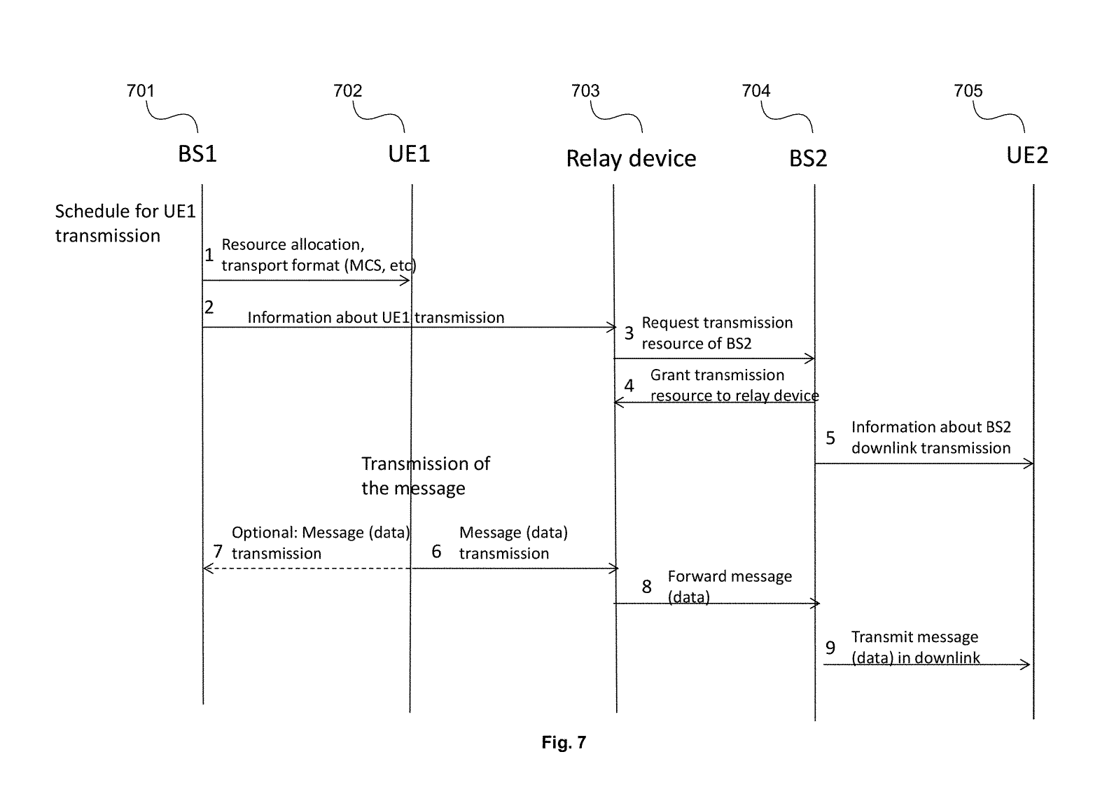

An example of a signalling exchange that may be employed in the scenario of FIG. 6 is shown in FIG. 7. In this example, the radio resources have to be scheduled (e.g. as defined by: 3GPP, “TS 36.321, Evolved Universal Terrestrial Radio Access (E-UTRA); Medium Access Control (MAC) protocol specification,” V12.9.0, March 2016). In step 1, BS1 (701) allocates the radio resources that UE1 (702) needs to transmit its message. The BS1 also configures the relay device to receive the transmission by sending it information about the allocated resources (step 2). This information might define, for example, the time and frequency slot that will be used by UE1. The relay device (703) is configured to receive this information from BS1 and use it to listen to the message transmitted by UE1 (step 6). The relay device thus receives the message over the uplink.

In FIG. 7, the relay device (703) requests radio resource from BS2 (704) for forwarding the message in BS2's spectrum once it receives the scheduling information about the transmission by UE1 (702) (step 3). BS2 grants the resource to the relay device (step 4) and also informs UE2 (705) about the upcoming transmission (step 5). Note that FIG. 7 shows steps 3 to 5 as being executed before the data transmission by UE1, but they could equally be executed after the data transmission. The relay device is configured to then transmit the message to UE2 using the requested radio resources.

In order to enable the above procedure, the relay device is preferably registered in the first network as a device that is granted permission to receive and decode messages send by remote devices in that network. The network may configure the relay device to be able to decode messages. For example, the network may provide the relay device with the Modulation and Coding Scheme (MCS) used by UE1. This information may be provided with the transmission information in step 2 of FIG. 7. Referring to the relay device (300) shown in FIG. 3, the reformatter 304 may be configured to implement a decode-and-forward scheme, with decode unit 303 being configured to decode received messages in dependence on the information received from the network.

The relay device is preferably registered in the second network as a relay device or as a common mobile device (i.e. a UE) that is granted permission to transmit in that network.

In the example of FIG. 7, radio resources were requested from the networks before data was transmitted. Another option is to apply a grant-free scheme, which may be particularly appropriate for delay-critical communications. In this scenario the steps for requesting and granting radio resources can be skipped.

Referring to the example of FIG. 7, in a grant-free scheme the message from UE1 (702) would be transmitted using pre-allocated radio resource. The relay device is configured to listen to that pre-allocated radio resource, and is therefore able to receive the message from UE1 without having to receive information about the specific message transmission by UE1 from the first network beforehand.

The network does, however, preferably inform the relay device about this pre-allocation so that the relay device is configured to listen to the correct resource grid. Radio resources in the second network may be similarly reserved and assigned to the relay device so that the relay device can apply the same grant-free scheme for the relay transmission. The relay device may therefore be configured to transmit the message from UE1 to UE2 (705) over a radio resource that is pre-allocated to relaying data to the second network. This enables the relay device to transmit the message to UE2 without having to request radio resources for that specific transmission from the second network beforehand.

In another alternative to the example of FIG. 7, the UE1 (702) may transmit its message to the relay device (703) using a direct link rather than an uplink. This generally involves UE1 and the relay device operating in a device-to-device (D2D) communication mode. An example of such a direct link is the side link (PC5) implemented by some of the 3GPP LTE standards (see e.g. 3GPP, “TS 23.303, Proximity-based services (ProSe); Stage 2,” V14.0.0, September 2016). The D2D link between UE1 and the relay device is established after a D2D discovery procedure before the actual D2D data transmission. D2D discovery and link establishment can be achieved using direct discovery, network based discovery, application-level discovery, etc. These options are described in more detail in 3GPP, “TR 23.703, Study on architecture enhancements to support Proximity-based Services (ProSe),” February 2014. D2D transmission may be controlled and scheduled by UE1 and the relay device rather than the network (i.e. by base station BS1), in which case steps 1 and 2 in FIG. 7 can be omitted.

Relay Messages from a Transmitting Base Station

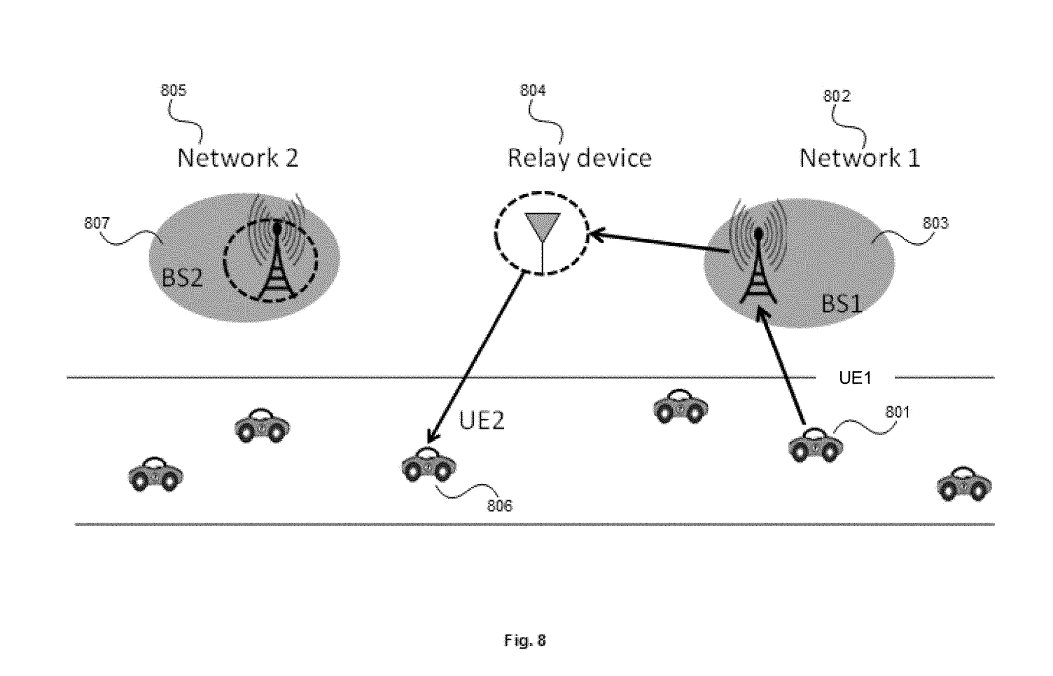

An example of this scenario is shown in FIG. 8. The relay device 801 is configured to receive data from a base station BS1 803 in the first network 802. UE1 is connected to a network device BS1 (604) in Network 1 and hence transmits its message using the spectrum of BS1. The message sent by UE1 is firstly received by BS1, which UE1 is connected to, and then BS1 transmits the message to the relay device in its spectrum. The relay device thus receives the data as a message from network device (803) that is transmitted in the spectrum of Network 1.

The relay device listens to the message from BS1 using the first section of spectrum used by BS1. The message is to be relayed to UE2 (806), which is part of the second network 805. The relay device listens to the message sent by BS1 and forwards it to UE2 via the downlink in the spectrum of Network 2 (805). So, in this example the relay device is configured to transmit the data to a remote device (806) in the second network (805). In this scheme, the original message does not necessarily have to come from UE1; it may come from any device or service in the network and be transmitted by BS1 to the relay device.

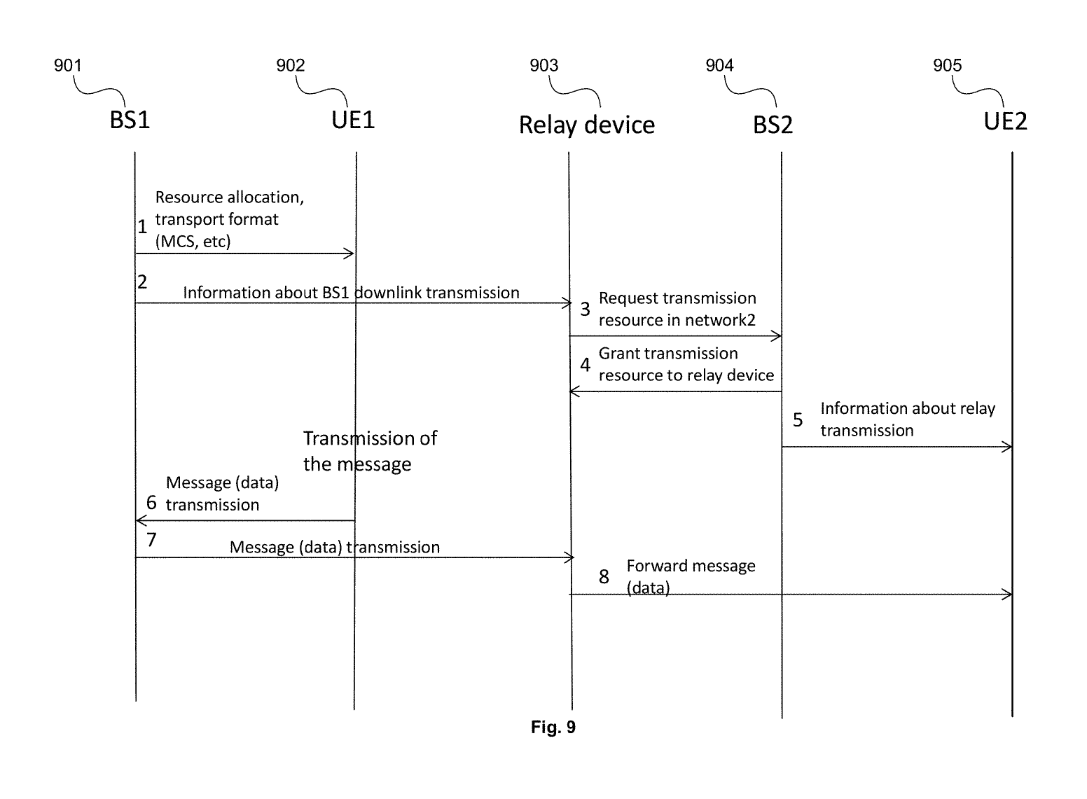

An example of a signalling exchange that may be employed in the scenario of FIG. 8 is shown in FIG. 9. There are three communication scenarios that are particularly relevant for V2X communications—namely broadcasting, multicasting and unicasting—and these are described in more detail below.

### Broadcast

In this scenario UE1 (801) sends a broadcast message via BS1 (803). BS1 also sends the message via the broadcast channel. The relay device (804) is configured to listen to the broadcast channel for messages that it should relay to the second network (805). When it receives the message, it forwards it to the second network on a broadcast channel of the second network. BS2 (807) receives the message via the broadcast channel and forwards it to UE2 on its broadcast channel. UE2 listens to the broadcast channel of BS2 and thus receives the message.

The relay device (300) is preferably configured such that its decode unit (303) can decode messages broadcast in the first network. For an LTE implementation, a System Information Radio Network Temporary Identifier (SI-RNTI) is used to broadcast system information (see 3GPP, “TS 36.321, Evolved Universal Terrestrial Radio Access (E-UTRA); Medium Access Control (MAC) protocol specification,” V12.9.0, March 2016). The SI-RNTI is a common RNTI; it is not allocated to any remote device explicitly. The SI-RNTI is of 16-bit in length and its value is fixed to 65535 (0xFFFF). Thus, providing the relay device is in possession of the SI-RNTI, it should be able to unscramble broadcast messages.

### Multicast

If UE1 (801) sends a multicast message, one or more UEs that are due to receive that message might be identified as belonging to a network outside of Network 1 (802). In the example of FIG. 8, this is UE2 (806), which is part of the multicast group but is currently located in Network 2 (805). To deal with this situation, the relay device (804) is registered in the first or second network as being part of one or more multicast groups of remote devices that are registered in that respective network. In the case of FIG. 8, the relay device is subscribed in Network 1 as a default UE for this multicast group. The relay device thus receives the message from BS1 (803) and forwards it to UE2 in the spectrum of Network 2.

Referring to the signalling exchange shown in FIG. 9, BS1 (901) sends the resource allocation information to UE1 (902) in step 1. It also informs the relay device (903) about the downlink transmission it has scheduled to forward this message to the relay device (step 2). Thereafter, the relay device requests the transmission resource it needs from BS2 (904) (step 3). BS2 grants the resource to the relay device (step 4) and informs UE2 of the scheduled relay transmission (step 5). A notification about the relay transmission can be sent via BS2 (step 5) or directly from the relay device. (Note that as before, steps 3,4,5 can also be executed after the actual data transmission in steps 6 and 7). The relay device then transmits the message to remote device UE2 (905) on the downlink using the spectrum of the second network.

The relay device (300) is preferably configured such that its decode unit (303) can decode messages multicast in the first network. For an LTE implementation, if a Multimedia Broadcast Multicast Service (MBMS) scheme is applied for multicasting then an M-RNTI (MBMS RNTI) is used on the Physical Downlink Control Channel (PDCCH) (see e.g. 3GPP, “TS 36.321, Evolved Universal Terrestrial Radio Access (E-UTRA); Medium Access Control (MAC) protocol specification,” V12.9.0, March 2016). In LTE the Downlink Control Information format 1C with M-RNTI is used for notification. It includes an 8-bit bitmap to indicate the one or more Multi-Broadcast Single Frequency Network (MBSFN) area(s) in which the Multicast Control Channel (MCCH) changes. The M-RNTI is of 16-bit in length and its value is fixed to 65533 (0xFFFD). Thus, the relay device should be able to unscramble broadcast messages. Indeed, the relay device does not even need to subscribe and register in Network 1.

### Unicast

If UE1 (801) sends a unicast message via BS1 (803), BS1 is configured to identify that the target UE (UE2: 806) belongs to a different network. BS1 notifies the relay device (804) about the transmission request. The signalling exchange is similar to that described above with respect to the multicast case, with the relay device requesting radio resources in Network 2 (step 3) and informing UE2 about the relay transmission (step 5). The relay device then transmits the message to remote device UE2 (905) on the downlink using the spectrum of the second network (step 8).

A similar grant-free scheme can be applied to the scenario illustrated in FIG. 8 as that FIG. 6. In other words, pre-allocated resource can be used for transmitting messages involved in the relay, which enables steps of resource request and grant to be skipped.

As before, the relay device may make use of direct links instead of just using the conventional uplink/downlink. For example, in the scenario of FIG. 8 the relay device (804) may use a direct link to forward the message to UE2 (806). In this case, the D2D link between the relay device and UE2 should be discovered and established before the data transmission (step 8 in FIG. 9). If the D2D transmission is not controlled and scheduled by the network, i.e. by the base station BS2 (904), then steps 3, 4 and 5 in FIG. 9 can be omitted.

Again, the relay device is registered in the first network as a device that has permission to receive and decode data transmitted by a network device in the first network. In order to support the messages that are sent by BS1, the relay device may be registered in Network 1 as a relay or a common UE. The relay device may be registered in Network 1 as a special relay device. A special relay device is one with restricted relay function. For example, the device may only be configured to do one of transmitting or receiving messages in each network.

The relay device is preferably registered in the second network as a device that is granted permission to transmit messages to remote devices in the second network. The network may configure the relay device to be able to transmit messages to the remote devices. For example, the network may provide the relay device with the modulation and coding scheme (MCS) that the relay device should use for transmission. This information may be provided with the transmission information in step 4 of FIG. 9.

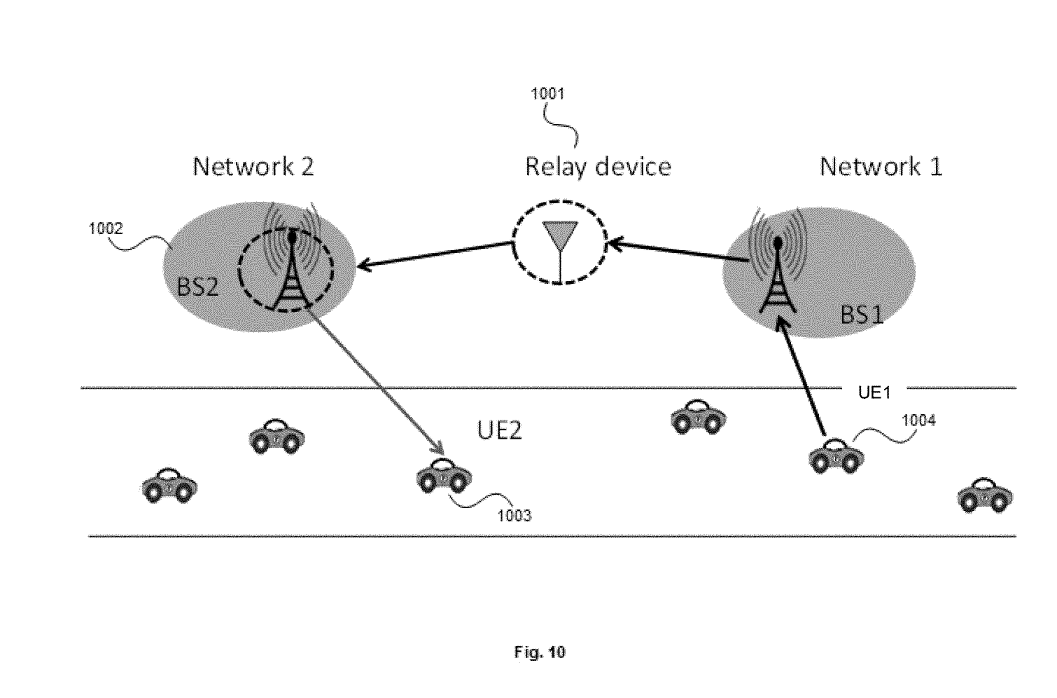

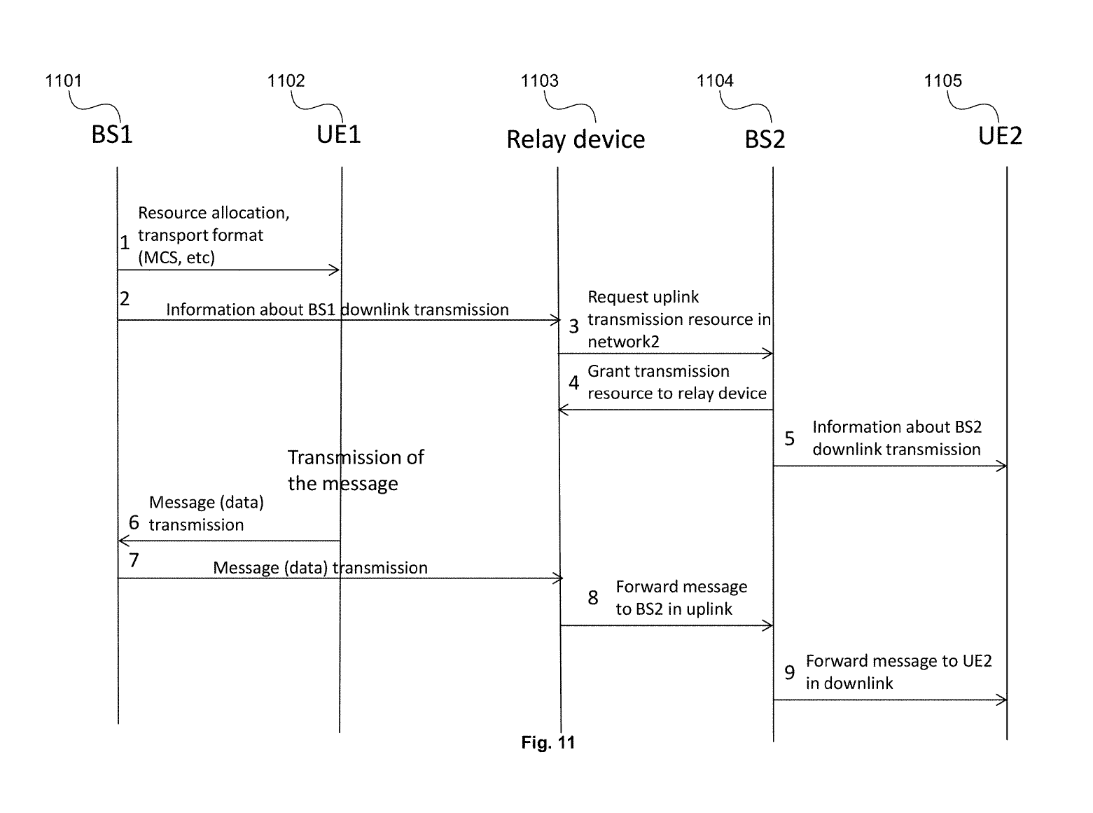

FIG. 10 shows a variation of the relay scheme illustrated in FIG. 8. In this example the relay device (1001) forwards the message to the base station (1002) of the target UE (1003), and the message is then transmitted by the base station to the target UE. The relay device suitably receives the message from the transmitting UE (1004) via the spectrum of the first network and forwards it to the base station of the target UE in the spectrum of the second network. In this case, the relay device can be registered in both networks as a common UE. FIG. 11 shows an example of a signalling exchange between the base stations BS1 and BS2 (1101, 1104), the UEs (1102, 1105) and the relay device (1103).

### Relay Messages Via a Direct Link

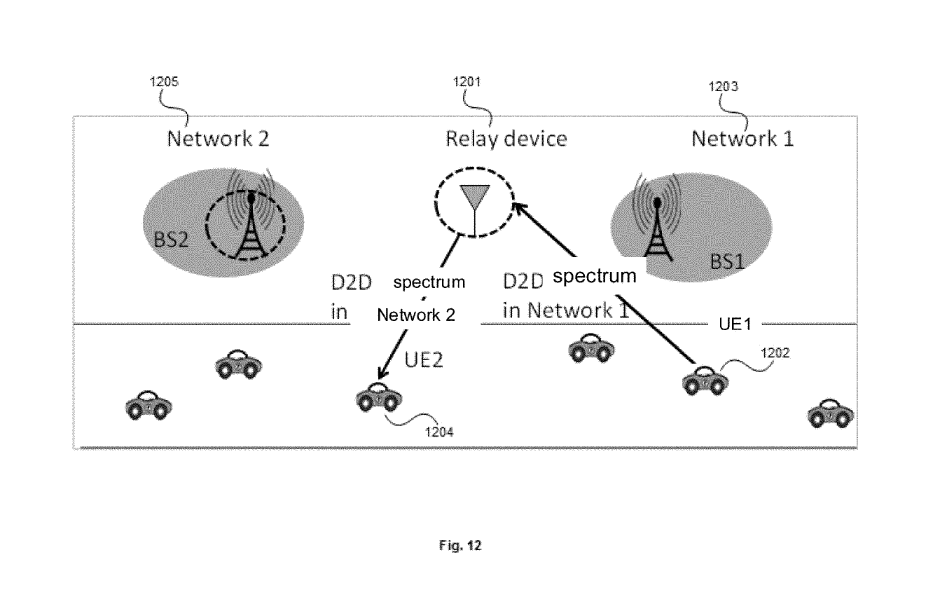

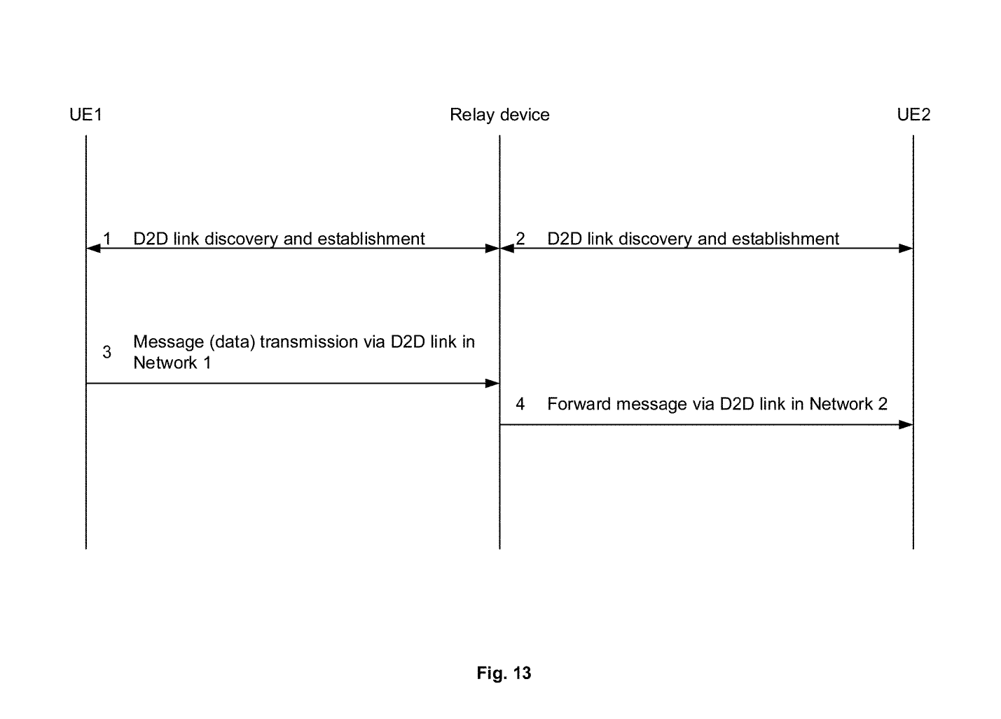

An example of this scenario is shown in FIG. 12. In this scenario the relay device (1201) is configured to receives messages from the transmitting remote device UE1 (1202) via a D2D link in the network (1203) of the transmitting UE. The relay device forwards the messages to the target UE (1204) via the D2D link in the network (1205) of the target UE. The D2D transmission from UE1 to the relay device uses the spectrum in Network 1, and the D2D transmission from the relay device to UE2 uses the spectrum in Network 2. Similar to the previous schemes, the D2D links have to be discovered and established before the D2D transmission (as illustrated in FIG. 13).

The concepts described above are applicable to scenarios in which multiple networks are deployed at the same geographical area. Some of the remote devices are subscribed, registered and connected in one network. They need to be able to communicate with one or more other remote devices that are subscribed, registered and connected in other networks. The concepts described above address the problem that message and data exchange between the remote devices should fulfil strict delay requirements that cannot be achieved through the typical communication path that involves crossing all domains (i.e., access, transport and core network) of multiple networks. This problem is addressed by means of a relay device that is configured to efficiently relay messages from one network to another, providing a shortcut that significantly reduces delay.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present embodiments of the invention may consist of any such individual feature or combination of features. In view of the foregoing description it will be evident to a person skilled in the art that various modifications may be made within the scope of the embodiments of the invention.

What is claimed is:

1. A relay device for operating in a communication system that comprises at least two individual networks, wherein each network comprises a network device and a remote device that are configured to wirelessly transfer data between them, the relay device being configured to:
receive data transmitted by a device in a first one of the networks over a first section of radio spectrum; and
transmit that data to a device in a second one of the networks over a second section of radio spectrum that is different from the first section of radio spectrum.

2. A relay device as claimed in claim 1, wherein the relay device is configured to receive the data from a network device or from a remote device in the first network.

3. A relay device as claimed in claim 1, wherein the relay device is configured to transmit the data to a network device or to a remote device in the second network.

4. A relay device as claimed in claim 1, wherein the relay device is configured to be able to decode the data transmitted by the device in the first network.

5. A relay device as claimed in claim 1, wherein the relay device is configured to:
receive information from a network device about a transmission, in the first network, of data that the relay device should relay to the second network; and
listen for that data transmission in dependence on that information.

6. A relay device as claimed in claim 1, wherein the relay device is configured to listen to a radio resource that is pre-allocated by the first network for data that should be relayed to the second network, the relay device thereby being capable of receiving the data transmitted by the device in the first network without having to receive information about that transmission from the first network beforehand.

7. A relay device as claimed in claim 1, wherein the relay device is configured to:
listen to a broadcast channel of the first network for data that it should relay to the second network; and
if it receives data over the broadcast channel of the first network that it should relay to the second network, relay that data by transmitting it on a broadcast channel of the second network.

8. A relay device as claimed in claim 1, wherein the relay device is registered in the first network as being part of one or more multicast groups of remote devices that are registered in that respective network.

9. A relay device as claimed in claim 1, wherein the relay device is configured to:
request radio resources from a network device in the second network for transmitting the data that it received from a device in the first network to a device in the second network; and
transmit that data to the device in the second network using the requested radio resources.

10. A relay device as claimed in claim 1, wherein the relay device is configured to transmit the data that it received from the device in the first network to the device in the second network over a radio resource that is pre-allocated to relaying data to the second network, the relay device thereby being capable of transmitting the data to the device in the second network without having to request radio resources from the second network beforehand.

11. A relay device as claimed claim 1, wherein the relay device is registered in the first network and/or in the second network as a device that has permission to perform one or more of: receiving data, transmitting data and decoding data.

12. A relay device as claimed in claim 1, wherein the relay device is registered in the first network and/or the second network as one or more of: a remote device; a common remote device; a relay device; and a special relay device.

13. A method for relaying data in a communication system that comprises at least two individual networks, wherein each network comprises a network device and a remote device that are configured to wirelessly transfer data between them, the method comprising:
receiving data transmitted by a device in a first one of the networks over a first section of radio spectrum at a relay device; and
transmitting that data from the relay device to a device in a second one of the networks over a second section of radio spectrum, which is different from the first section of radio spectrum.

14. A method as claimed in claim 13, wherein the method comprises:
receiving information from a network device about a transmission, in the first network, of data that the relay device should relay to the second network; and
listening for that data transmission in dependence on that information.

15. A method as claimed in claim 13, wherein the method comprises: listening to a radio resource that is pre-allocated by the first network for data that should be relayed to the second network, the relay device thereby being capable of receiving the data transmitted by the device in the first network without having to receive information about that transmission from the first network beforehand.

16. A method as claimed in claim 13, wherein the relay device is registered in the first network as being part of one or more multicast groups of remote devices that are registered in that respective network.

17. A method as claimed in claim 13, wherein the method comprises:
requesting radio resources from a network device in the second network for transmitting the data that it received from a device in the first network to a device in the second network; and
transmitting that data to the device in the second network using the requested radio resources.

18. A method as claimed in claim 13, wherein the method comprises:
transmitting the data that it received from the device in the first network to the device in the second network over a radio resource that is pre-allocated to relaying data to the second network, the relay device thereby being capable of transmitting the data to the device in the second network without having to request radio resources from the second network beforehand.

19. A non-transitory machine readable storage medium having stored thereon processor executable instructions implementing a method for relaying data in a communication system that comprises at least two individual networks, wherein each network comprises a network device and a remote device that are configured to wirelessly transfer data between them, wherein the instructions implement a method comprising:
receiving data transmitted by a device in a first one of the networks over a first section of radio spectrum at a relay device; and
transmitting that data from the relay device to a device in a second one of the networks over a second section of radio spectrum, which is different from the first section of radio spectrum.

20. A network device that is configured to:
allocate radio resources to a transmission of data, wherein said data is to be relayed from a first network, which is configured to communicate its data using a first section of radio spectrum, to a second network, which is configured to communicate its data using a second section of radio spectrum that is different from the first section of radio spectrum; and
facilitate the relaying of that data from the first network to the second network by configuring a device that is intended to receive the data transmission to receive that transmission via the allocated radio resources.
